(19) United States
(12) Patent Application Publication
(10) Pub. No.: US 2026/0303620 A1
(43) Pub. Date: Oct. 1, 2026

(54) DETECTION AND AGGREGATION OF SUSPICIOUS CLOUD PROVIDER ENTITY BEHAVIOR

(71) Applicant: CrowdStrike, Inc., Sunnyvale, CA (US)

(72) Inventors: Rico Valdez, Albuquerque, NM (US); Daniel Brown, Ipswich, MA (US)

(21) Appl. No.: 19/097,259

(22) Filed: Apr. 1, 2025

(51) Int. Cl. H04L 9/40

(52) U.S. Cl. CPC H04L 63/1416

(57) ABSTRACT

The present disclosure provides techniques for detection and aggregation of suspicious cloud provider entity behavior. A processing device obtains indications of events associated with user accounts of a cloud provider. The processing device generates scores for the events based on the indications of the events and previous occurrences of the events associated with the user accounts of the cloud provider. The processing device aggregates a subset of the scores for a user account in the user accounts based on each score in the subset of scores meeting a threshold score and a subset of the events corresponding to the subset of the scores occurring with a time period. The processing device outputs an indication that the user account is compromised based on the aggregated subset of the scores.

### TECHNICAL FIELD

Aspects of the present disclosure relate to cybersecurity, and more particularly, to detection and aggregation of suspicious cloud provider entity behavior.

### BACKGROUND

Cybersecurity refers to the practice of protecting computer systems, networks, and digital assets from theft, damage, unauthorized access, and various forms of cyber threats. Cybersecurity threats encompass a wide range of activities and actions that pose risks to the confidentiality, integrity, and availability of computer systems and data. These threats can include malicious activities such as viruses, ransomware, and hacking attempts aimed at exploiting vulnerabilities in software or hardware.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example of a system for detection and aggregation of suspicious cloud provider entity behavior in accordance with some aspects of the present disclosure.

FIG. 2 is a flow diagram of a method of detection and aggregation of suspicious cloud provider entity behavior in accordance with some aspects of the present disclosure.

FIG. 3 is a flow diagram of a method of detection and aggregation of suspicious cloud provider entity behavior in accordance with some aspects of the present disclosure.

FIG. 4 is a block diagram that illustrates an example of a system for detection and aggregation of suspicious cloud provider entity behavior in accordance with some aspects of the present disclosure.

FIG. 5 illustrates a diagrammatic representation of a machine in an example form of a computer system that may perform one or more of the operations described herein in accordance with some aspects of the present disclosure.

### DETAILED DESCRIPTION

A cloud provider (which may also be referred to as a cloud service provider) may provide computing services and/or storage services to users via user accounts with the cloud provider. Example cloud providers may include (e.g., Amazon Web Services (AWS®), Microsoft Azure®, Google Cloud®, etc.). In an example, employees of an organization (e.g., a company) may have user accounts with the cloud provider. A user may log on to the cloud provider via a user account, and the user may utilize services provided by the cloud provider to perform tasks. For instance, the user may perform data analytics tasks on data stored within cloud storage of the cloud provider. Malicious actors are increasingly targeting user accounts of cloud providers due to increased use of services provided by cloud providers. In an example, a malicious actor may gain access to a user account of a user (e.g., via social engineering) and obtain information that the malicious actor is not authorized to access via the user account.

Some cybersecurity approaches to detecting compromised user accounts of a cloud provider may be based on an audit log of the cloud provider. The audit log may include indications of events (e.g., application programming interface (API) calls) performed by the user accounts with respect to the cloud provider, timestamps of the events, and identifiers for user accounts associated with the events (e.g., identifiers for user accounts that performed by the API calls). The audit log may include large numbers of events due to the complexity of services provided by the cloud provider. Some events in the audit log may be relevant for cybersecurity purposes (e.g., for detecting compromised user accounts), whereas other events in the audit log may not be relevant for cybersecurity purposes. Additionally, the audit log may include large numbers of repetitive events. As such, processing the audit log for cybersecurity purposes may be computationally burdensome due to the large number of events indicated in the audit log. Some audit log based approaches for detecting compromised user accounts of a cloud provider may include looking for indications of configurations of user accounts in the audit log that may cause vulnerable conditions or looking for specific indicators of specific events in the audit log, such as matching internet protocol (IP) addresses against blacklists to determine if the user accounts have been compromised. However, such audit log based approaches may only account for a small subset of available events in the audit log. As such, analyzing the audit log for cybersecurity purposes may be computationally difficult (e.g., consume a relatively large amount of processor clock cycles) and/or may have trouble accurately identifying compromised user accounts.

The present disclosure addresses the above-noted and other deficiencies by using a processing device for detecting and aggregating suspicious cloud entity behavior (i.e., suspicious user account activity in a cloud environment). In an example, a processing device obtains an audit log from a cloud provider. The audit log includes indications of events performed with respect to the cloud provider, timestamps for the events, and identifiers for user accounts associated with the events. In an example, the events may include application programming interface (API) calls by the user accounts to the cloud provider. In an example, the API calls may include an API call to determine which storage locations of the cloud provider are accessible to a user account. The processing device scores the events based on the timestamps for the events in the audit log and previous occurrences of the events. In one example, the previous occurrences of the events may be included in the audit log. For instance, the audit log may indicate that an event occurred at a first time instance for the user account and that the event occurred at a second time instance for the user account. In an example, a relatively higher score may indicate an infrequent occurrence of the event for the user account and a relatively lower score may indicate a frequent occurrence of the event for the user account. The processing device may aggregate subsets of the scores for the user accounts and subsets of the events based on each score meeting a first threshold score and each event occurring within a time period. For instance, for the user account, the processing device may collect a subset of scores in the scores that meet a threshold score and a subset of events in the events that occur within the time period. The processing device may generate a score for the user account (i.e., an overall score for the user account) based on the aggregated subset of the scores for the users account. The processing device may output an indication that the user account is compromised (e.g., a malicious actor has gained access to the user account) based on the overall score for the user account meeting a second threshold score. For instance, the processing device may transmit an indication to a security analyst computing device indicating that the user account is compromised (or likely compromised). The processing device may also restrict access of the user account to the cloud provider (or cause access of the user account to be restricted) based on the indication.

In an example, a processing device obtains indications of events associated with user accounts of a cloud provider. The processing device generates scores for the events based on the indications of the events and previous occurrences of the events associated with the user accounts of the cloud provider. The processing device aggregates a subset of the scores for a user account in the user accounts based on each score in the subset of scores meeting a threshold score and a subset of the events corresponding to the subset of the scores occurring with a time period. The processing device outputs an indication that the user account is compromised based on the aggregated subset of the scores.

As discussed herein, the present disclosure provides an approach that improves the operation of a computer system by reducing an amount of computational resources (e.g., processor clock cycles) used to determine whether a user account with a cloud provider is compromised. For instance, via generating the scores and aggregating the subset of the scores as described above, a computing system may reduce an amount of computing resources used to determine with a user account with a cloud provider is compromised. Moreover, the approach to detecting compromised user accounts of a cloud provider described herein does not require the usage of a machine learning (ML) model (which may be computationally burdensome to train and retrain). Furthermore, the approach to detecting compromised user accounts with a cloud provider described herein may determine that a user account is compromised without regard to specific event types associated with the user account, and thus the approach described herein may avoid processing associated with specific event types. In addition, the present disclosure provides an improvement to the technological field of cybersecurity by more accurately detecting compromised user accounts of a cloud provider compared to existing audit log based approaches. For instance, via generating the scores and aggregating the subset of the scores as described above, a computing system may more accurately detect compromised user accounts of a cloud provider.

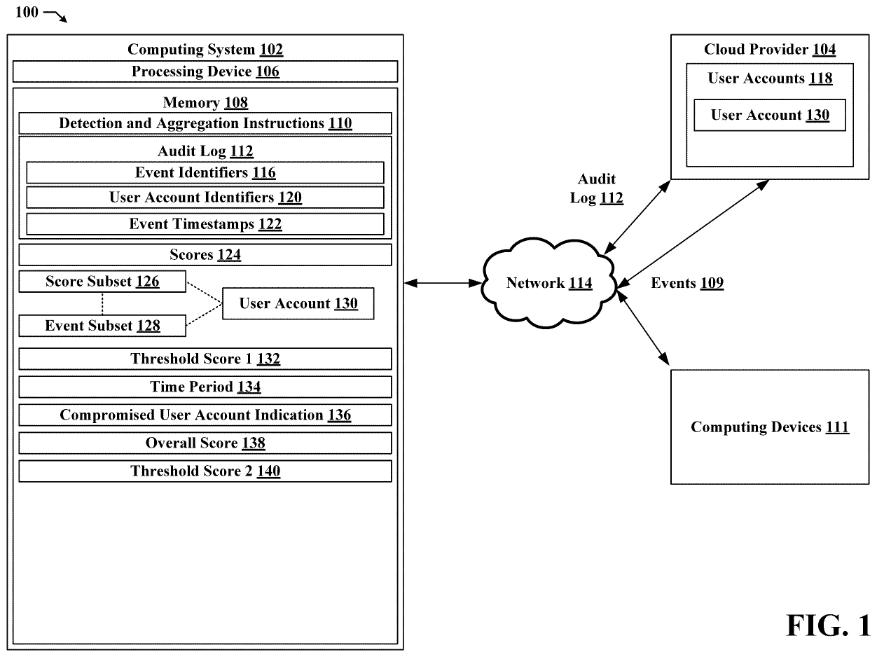

FIG. 1 is a block diagram 100 that illustrates an example of a system for detection and aggregation of suspicious cloud provider entity behavior in accordance with some aspects of the present disclosure. The system includes a computing system 102 and a cloud provider 104. Although the computing system 102 and the cloud provider 104 are described in the following description as separate (i.e., the computing system 102 is not under control of an owner of the cloud provider 104), it is to be understood that in some aspects, the cloud provider 104 may include the computing system 102 (i.e., the computing system 102 may be a device associated with/controlled by/owned by the cloud provider 104). As such, in some aspects, device(s) of the cloud provider 104 may perform the functionality described herein for detecting and aggregating suspicious cloud entity behavior (i.e., suspicious user account activity in a cloud environment).

The computing system 102 includes a processing device 106 and memory 108. The memory 108 stores detection and aggregation instructions 110 that, when executed by the processing device 106, cause the processing device 106 to implement functionality pertaining to detecting and aggregating suspicious cloud entity behavior (i.e., suspicious user account activity in a cloud environment) described herein. It is to be understood that the computing system 102 may include other components not depicted in FIG. 1. For example, the computing system 102 may be or include the computer system 500 (or a portion thereof). In an example, the computing system 102 may be associated with (e.g., owned by, controlled by, operated by, etc.) an organization that provides cybersecurity related services to clients.

It is contemplated that events 109 initiated by user accounts 118 occur with respect to the cloud provider 104. The cloud provider 104 generates an audit log 112 (described below) based on the events 109. For example, computing devices 111 operated by users associated with the user accounts 118 may perform API calls to the cloud provider 104. In an example, a computing device in the computing devices 111 may transmit, via a user account 130 in the user accounts 118, an API call that requests a list of storage locations (e.g., buckets) of the cloud provider 104 that are accessible to the user account 130. In an example, the user account 130 may be a compromised user account, that is, a malicious actor (who is not the authorized user of the user account 130) may have gained access to the user account 130. Aspects described herein pertain to detecting that the user account 130 is a compromised user account.

The computing system 102 may obtain the audit log 112 from the cloud provider 104 (i.e., the computing system 102 may obtain the audit log 112 from device(s) associated with the cloud provider 104). In an example, the computing system 102 may receive the audit log 112 from the cloud provider 104 (i.e., from device(s) of the cloud provider 104) via a network 114 (e.g., the Internet).

The audit log 112 comprises identifiers for events (i.e., event identifiers 116) associated with the user accounts 118 of the cloud provider 104, identifiers for the user accounts 118 (i.e., user account identifiers 120), and timestamps for the events (i.e., event timestamps 122). In an example, the event identifiers 116 may include identifiers for API calls performed by the user accounts 118 with respect to the cloud provider 104. In an example, an event may be performing an API call to determine cloud storage locations accessible to the user account 130, and as such, the event identifiers 116 in the audit log 112 may include an identifier for the API call to determine the cloud storage locations accessible to the user account 130, the user account identifiers 120 in the audit log 112 may include an identifier for the user account 130 that performed the API call to determine the cloud storage locations accessible to the user account 130, and the event timestamps 122 in the audit log 112 may include a timestamp (i.e., a date and a time) at which the API call to determine the cloud storage locations accessible to the user account 130 occurred.

The computing system 102 may compute scores 124 for events (identified by the event identifiers 116) for the user accounts 118 based on the event timestamps 122 and based on previous occurrences of the events for the user accounts 118. In some aspects, a previous occurrence of an event may be included in the audit log 112. For example, the audit log 112 may include, for a user account that has an identifier in the user account identifiers 120, a first instance of an event identifier (in the event identifiers 116) and a first timestamp (in the event timestamps 122) and a second instance of the event identifier (in the event identifiers 116) and a second timestamp (in the event timestamps 122). In some other aspects, the previous occurrence of the event (or an indication thereof) may be stored separately from the audit log 112. For instance, the previous occurrence of the event (e.g., the second instance of the event identifier and the second timestamp) may be included in/indicated by a previous audit log (not depicted in FIG. 1) or the previous occurrence of the event (e.g., the second instance of the event identifier and the second timestamp) may be stored in data storage (e.g., in the memory 108). In an example, the computing system 102 may compute a score in the scores 124 for the event based on the first timestamp and the second timestamp. For instance, the computing system 102 may compute a difference between the first timestamp and the second timestamp. The computing system 102 may compute a quotient of the difference and a base rate (e.g., an hour, six hours, a day, etc.). The computing system 102 may then compute a logarithm of the quotient to obtain the score. In an example, if the score is relatively high, the event may be correlated with a relatively infrequent use of an API, whereas if the score is relatively low, the event may be correlated with a relatively frequent use of the API. In some aspects, the score may be indicative of an unusualness of the event for the user account. In some aspects, each score in the scores 124 may be independent from a type of an event corresponding to each score, that is, each score 124 may be based on an occurrence of the event and a previous occurrence of the event, but not a type of the event.

In some aspects, the term “a previous occurrence of an event,” or the like, refers to the following: upon processing an event (i.e., “a current event”) in a data set or an event stream, if the computing system 102 has, in memory, a previous event (or an indication thereof) that has the same values for a user identifier (i.e., “UserID”) and a behavior as those of the current event, then the previous event is “a previous occurrence of the event.” The behavior may be an API call identifier. Both the event and the previous event may belong to a same group in the sense of a group-by operation.

The computing system 102 may aggregate a subset of the scores 124 (i.e., a score subset 126) for a subset of the events 109 (i.e., an event subset 128) for the user account 130 based on a first threshold score 132 and a time period 134. In an example, after computing the scores 124, the computing system 102 may obtain the score subset 126 for the user account 130 by filtering out score(s) in the scores 124 that are not associated with the user account 130 (e.g., using the user account identifiers 120), filtering out score(s) in the scores 124 that do not meet the first threshold score 132 (e.g., filtering out score(s) that are less than the first threshold score 132), and by filtering out score(s) in the scores 124 corresponding to events that did not occur within the time period 134 (e.g., by using the event identifiers 116 and the event timestamps 122).

The computing system 102 may output an indication that the user account 130 is compromised (i.e., a compromised user account indication 136) based on the score subset 126. For example, the computing system 102 may compute an overall score 138 based on the score subset 126. For instance, the computing system 102 may sum each score in the score subset 126 to obtain the overall score 138. The computing system 102 may output the compromised user account indication 136 based on the overall score 138 meeting a second threshold score 140 (i.e., based on the overall score 138 exceeding the second threshold score 140).

It is contemplated that the computing system 102 may generate the scores 124 on an on-going basis. For instance, subsequent to generating the scores 124 and prior to aggregating the scores 124, the computing system 102 may obtain an indication of a new event associated with the user account 130. The computing system 102 may generate a score for the new event based on a previous occurrence of the event associated with the user account 130. The computing system 102 may aggregate the scores 124 (including the new score) as described above.

In some aspects, outputting the compromised user account indication 136 compromised may include displaying the compromised user account indication 136 on a display of the computing system 102. In some aspects, outputting the compromised user account indication 136 may include storing, in a data store, the compromised user account indication 136. In some aspects, outputting the compromised user account indication 136 may include transmitting the compromised user account indication 136 over the network 114 (e.g., to device(s) of the cloud provider 104). In some aspects, the computing system 102 may restrict the user account 130 based on the compromised user account indication 136. In some aspects, the computing system 102 may cause the user account 130 to be restricted based on the compromised user account indication 136. In some aspects, the compromised user account indication 136 may be an incident report object that may include information indicative of the (compromised) user account 130.

Although the description above describes the computing system 102 as obtaining the audit log 112, other possibilities are contemplated. In some aspects, the computing system 102 may obtain the event identifiers 116, the user account identifiers 120, and the event timestamps 122 as a part of an event stream received from the cloud provider 104.

As organizations shift workloads to the cloud, threat actors have begun to target cloud environments. Securing cloud resources of cloud environments may be challenging due to new architectures, security controls, and/or monitoring capabilities of the cloud environments. In a cloud environment, an audit log may be provided which may include indications of events associated with application programming interfaces (APIs) provided by the cloud environment. The audit log may include a large amount of information and a proper analysis of the audit log may identify malicious activity. However, due to the high number of entities, events, and benign, repetitive information included in the audit log, there may be a relatively large volume of data to process. As such, the audit log may oftentimes not be fully leveraged for security purposes.

Some approaches to security detection with respect to an audit log may include looking for indications of bad configurations that may cause vulnerable conditions (i.e., cloud posture security management (CSPM)) or looking for specific indicators in specific events, such as matching IP addresses against blacklists. In either case, security cases may typically look at only a small subset of available events in the audit log, as considering the security implications of all event types may be overwhelming to processing logic and/or an end user. As such, the aforementioned approaches may result in less than ideal security detections.

Described herein are various technologies pertaining to detection and aggregation of suspicious cloud provider entity behavior. In a first aspect described herein, each event in an audit log is scored based on a statistical significance of the event for relevant cloud entities (e.g., user accounts). The score may be based on an observation of an event stream and tracking a timestamp at which events occur. Higher scores may be correlated with infrequent use of a specific API call for a given cloud entity, as each entity may be tracked separately. In a second aspect described herein, the scores may be aggregated against a cloud entity (e.g., a user account) based on a dynamic time scale. This may allow for scores for events that are statistically determined to be related to each other to be grouped together in order to form a collection of relatively high-scoring events into a single object with a score that is based on the individual scores for activity of the cloud entity (i.e., a user account) in a relevant time frame.

As indicated above, every event may be first scored on a statistical significance of an event with regard to a cloud entity (e.g., a user account) responsible for the event. As the scoring may be based on an observation of an event stream, the scoring may not require training a machine learning (ML) model. Scores may be based on a lookback between an observed event and a last time at which the event was observed. As indicated above, other statistical methods may be used to group together events that are likely related and to combine scores and events to arrive at a grouping of suspicious activity for a given user account (i.e., a given user) without regard to specific event types being considered.

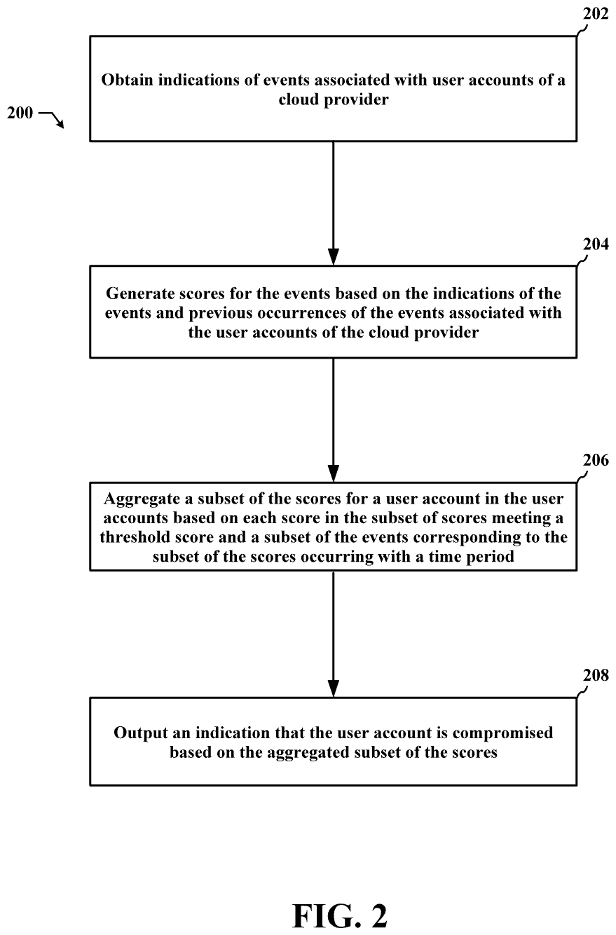

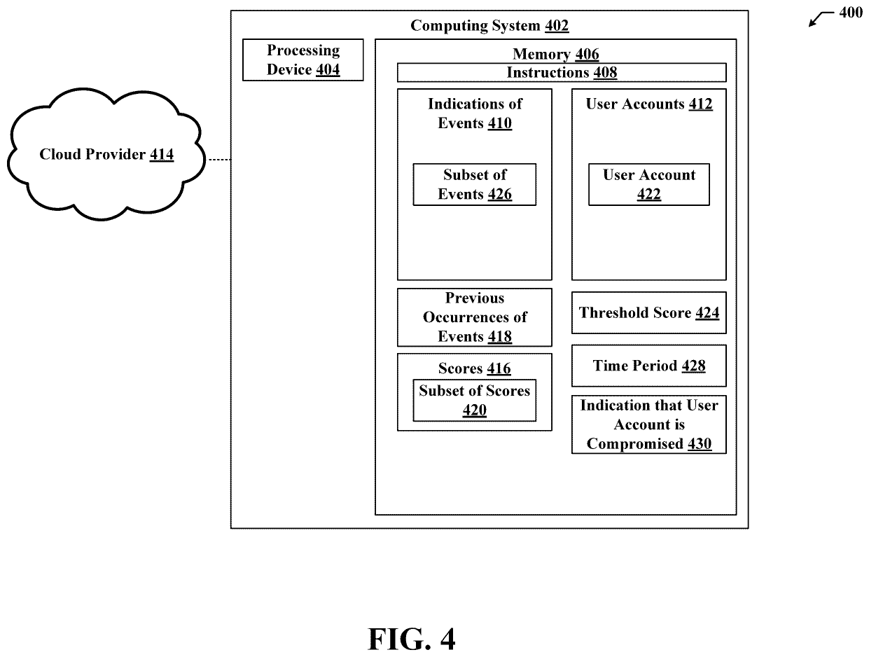

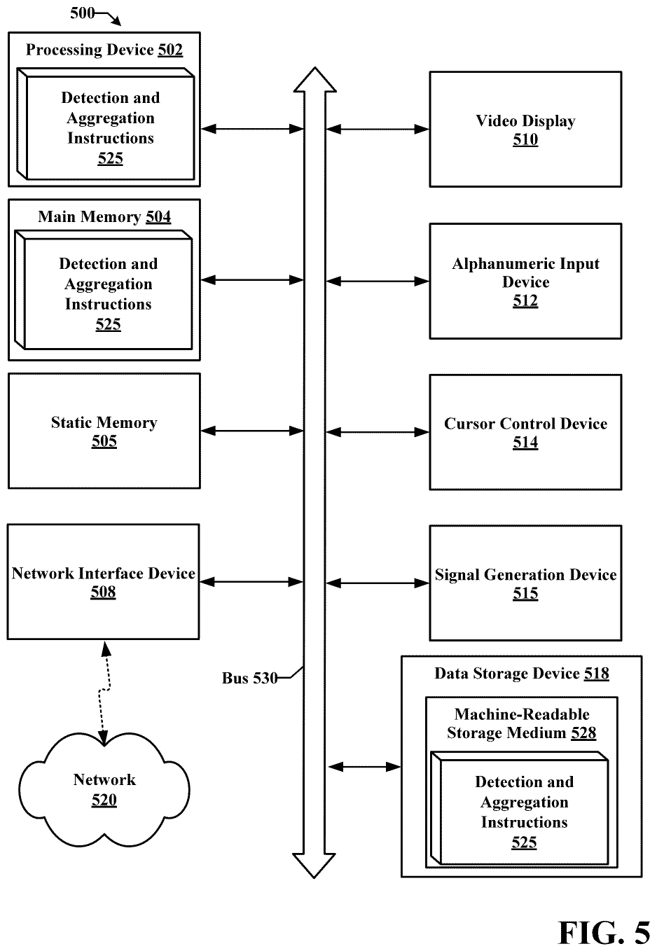

FIG. 2 is a flow diagram 200 of a method for detection and aggregation of suspicious cloud provider entity behavior in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the processing device 106 (shown in FIG. 1), the computing system 102 (shown in FIG. 1), the cloud provider 104 (shown in FIG. 1), the processing device 404 (shown in FIG. 4), the computing system 402 (shown in FIG. 4), the processing device 502 (shown in FIG. 5), the computer system 500 (shown in FIG. 5), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 202, a processing device obtains indications of events associated with user accounts of a cloud provider. In an example, the indications of the events associated with the user accounts may correspond to the event identifiers 116, the user account identifiers 120, and the event timestamps 122. In an example, the events may be or include the events 109, the user accounts may be or include the user accounts 118, and the cloud provider may be or include the cloud provider 104. In another example, the indications of events may be or include the indications of events 410, the user accounts may be or include the user accounts 412, and/or the cloud provider may be or include the cloud provider 414.

At block 204, the processing device generates scores for the events based on the indications of the events and previous occurrences of the events associated with the user accounts of the cloud provider. In an example, the scores may be or include the scores 124. In an example, the previous occurrences of the events may be indicated in the event identifiers 116, the user account identifiers 120, and the event timestamps 122. In another example, the previous occurrences of the events may be stored separately from the event identifiers 116, the user account identifiers 120, and the event timestamps 122. In another example, the scores for the events may be or include the scores 416 and the previous occurrences of the events may be or include the previous occurrences of the events 418.

At block 206, the processing device aggregates a subset of the scores for a user account in the user accounts based on each score in the subset of scores meeting a threshold score and a subset of the events corresponding to the subset of the scores occurring with a time period. In an example, the subset of the scores may be the score subset 126, the threshold score may be the first threshold score 132, the subset of the events may be the event subset 128, and the user account may be the user account 130. In another example, the subset of the scores for the user account may be or include the subset of scores 420, the user account may be or include the user account 422, the threshold score may be or include the threshold score 424, and/or the time period may be or include the time period 428.

At block 208, the processing device outputs an indication that the user account is compromised based on the aggregated subset of the scores. In an example, the indication that the user account is compromised may be or include the compromised user account indication 136. In another example, the indication that the user account is compromised may be or include the indication that the user account is compromised 430.

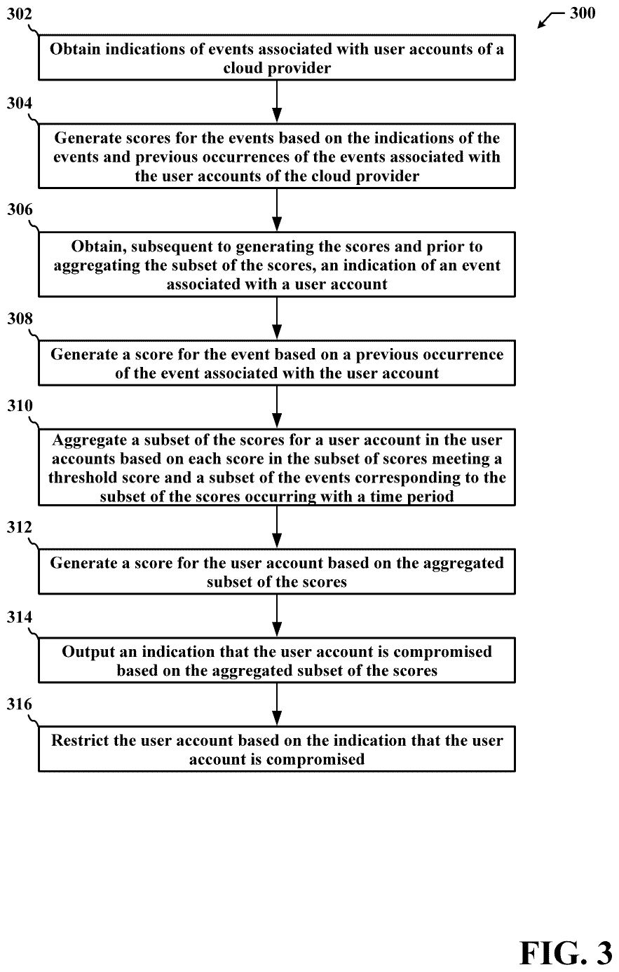

FIG. 3 is a flow diagram 300 of a method for detection and aggregation of suspicious cloud provider entity behavior in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the processing device 106 (shown in FIG. 1), the computing system 102 (shown in FIG. 1), the cloud provider 104 (shown in FIG. 1), the processing device 404 (shown in FIG. 4), the computing system 402 (shown in FIG. 4), the processing device 502 (shown in FIG. 5), the computer system 500 (shown in FIG. 5), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 302, a processing device obtains indications of events associated with user accounts of a cloud provider. In an example, the indications of the events associated with the user accounts may correspond to the event identifiers 116, the user account identifiers 120, and the event timestamps 122. In an example, the events may be or include the events 109, the user accounts may be or include the user accounts 118, and the cloud provider may be or include the cloud provider 104. In another example, the indications of events may be or include the indications of events 410, the user accounts may be or include the user accounts 412, and/or the cloud provider may be or include the cloud provider 414.

At block 304, the processing device generates scores for the events based on the indications of the events and previous occurrences of the events associated with the user accounts of the cloud provider. In an example, the scores may be or include the scores 124. In an example, the previous occurrences of the events may be indicated in the event identifiers 116, the user account identifiers 120, and the event timestamps 122. In another example, the previous occurrences of the events may be stored separately from the event identifiers 116, the user account identifiers 120, and the event timestamps 122. In another example, the scores for the events may be or include the scores 416 and the previous occurrences of the events may be or include the previous occurrences of the events 418.

In some aspects, at block 306, the processing device may obtain, subsequent to generating the scores and prior to aggregating the subset of the scores, an indication of an event associated with the user account. For example, the aforementioned aspect may correspond to the description of FIG. 1 above.

In some aspects, at block 308, the processing device may generate a score for the event based on a previous occurrence of the event associated with the user account, where aggregating the subset of the scores may include aggregating the subset of the scores additionally based on the score. For example, the aforementioned aspect may correspond to the description of FIG. 1 above.

At block 310, the processing device aggregates a subset of the scores for a user account in the user accounts based on each score in the subset of scores meeting a threshold score and a subset of the events corresponding to the subset of the scores occurring with a time period. In an example, the subset of the scores may be the score subset 126, the threshold score may be the first threshold score 132, the subset of the events may be the event subset 128, and the user account may be the user account 130. In another example, the subset of the scores for the user account may be or include the subset of scores 420, the user account may be or include the user account 422, the threshold score may be or include the threshold score 424, and/or the time period may be or include the time period 428

In some aspects, at block 312, the processing device may generate a score for the user account based on the aggregated subset of the scores, and outputting the indication that the user account is compromised may include outputting the indication that the user account is compromised based on the score exceeding a second threshold score. For example, the score may be or include the overall score 138.

At block 314, the processing device outputs an indication that the user account is compromised based on the aggregated subset of the scores.

In some aspects, at block 316, the processing device may restrict the user account based on the indication that the user account is compromised. In an example, the indication that the user account is compromised may be or include the compromised user account indication 136. In another example, the indication that the user account is compromised may be or include the indication that the user account is compromised 430.

In some aspects, obtaining the indications of the events associated with the user accounts of the cloud provider may include obtaining an audit log of the cloud provider, where the audit log may include identifiers for the events, identifiers for the user accounts, and timestamps of the events, and where generating the scores for the events may be based on the audit log. In an example, the audit log may be the audit log 112, the identifiers for the events may be the event identifiers 116, the identifiers for the user accounts may be the user account identifiers 120, and the timestamps of the events may be the event timestamps 122.

In some aspects, the indications of the events may include first timestamps of the events, identifiers for the events, and identifiers for the user accounts, and generating the scores for the events may include accessing data storage that stores second timestamps of the previous occurrences of the events occurring within the time period, identifiers for the previous occurrences of the events, and the identifiers for the user accounts and computing, for each event in the events for each user account in the user accounts, a score based on the first timestamps and the second timestamps. For example, the aforementioned aspect may correspond to the description of FIG. 1 above. In an example, the data storage may be or include the memory 108.

In some aspects, outputting the indication that the user account is compromised may include at least one of: displaying the indication that the user account is compromised, storing, in a data store, the indication that the user account is compromised, or transmitting, over a network and to a computing device, the indication that the user account is compromised. For example, the aforementioned aspect may correspond to the description of FIG. 1 above.

In some aspects, the events may include application programming interface (API) calls originating from the user accounts to the cloud provider. For example, the events 109 may include API calls.

In some aspects, each score in the scores may be indicative of an unusualness of an event for the user account. For example, each score in the scores 124 may be indicative of an unusualness of an event for the user account 130.

In some aspects, each score in the scores for the events may be independent from a type of an event. For example, each score in the scores 124 for the events 109 may be independent from a type of an event.

In some aspects, an event in the event may include an application programming interface (API) call to determine storage locations provided by the cloud provider that are accessible to the user account. For example, an event in the events 109 may include an API call to determine storage locations provided by the cloud provider 104 that are accessible to the user account 130.

In some aspects, outputting the indication that the user account is compromised may include generating an incident report object based on the aggregated subset of the scores. For example, the aforementioned aspect may correspond to the description of FIG. 1 above.

In some aspects, each score in the scores may be correlated with a frequency of use of an application programming interface (API) by the user account, where the API may be provided by the cloud provider. For example each score in the scores 124 may be correlated with a frequency of use of an API by the user account 130.

In some aspects, aggregating the subset of the scores for the user account may include selecting the subset of the events based on each of the subset of events being associated with an identifier for the user account and grouping the subset of the scores together based on the selected subset of the events. For example, the aforementioned aspect may correspond to the description of FIG. 1 above.

FIG. 4 is a block diagram 400 that illustrates an example of a computing system 402 for detection and aggregation of suspicious cloud provider entity behavior in accordance with some aspects of the present disclosure. In some aspects, the computing system 402 may perform some or all of the functionality described herein. The computing system 402 includes a processing device 404 and memory 406. The memory 406 stores instructions 408 that are executed by the processing device 404. The instructions 408, when executed by the processing device 404, cause the processing device 404 to obtain indications of events 410 associated with user accounts 412 of a cloud provider 414. The instructions 408, when executed by the processing device 404, cause the processing device 404 to generate scores 416 for the events 410 based on the indications of the events 410 and previous occurrences of the events 418 associated with the user accounts 412 of the cloud provider 414. The instructions 408, when executed by the processing device 404, cause the processing device 404 to aggregate a subset of the scores 420 for a user account 422 in the user accounts 412 based on each score in the subset of scores 420 meeting a threshold score 424 and a subset of the events 426 corresponding to the subset of the scores 420 occurring with a time period 428. The instructions 408, when executed by the processing device 404, cause the processing device 404 to output an indication that the user account is compromised 430 based on the aggregated subset of the scores 420.

FIG. 5 illustrates a diagrammatic representation of a machine in the example form of a computer system 500 within which a set of instructions, for causing the machine to perform any one or more of the methodologies discussed herein for detection and aggregation of suspicious cloud provider entity behavior.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, the computer system 500 may be representative of a server.

The computer system 500 includes a processing device 502, a main memory 504 (e.g., read-only memory (ROM), flash memory, dynamic random access memory (DRAM), a static memory 505 (e.g., flash memory, static random access memory (SRAM), etc.), and a data storage device 518 which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., an acoustic signal generation device, such as a speaker). In some embodiments, the video display unit 510, the alphanumeric input device 512, and the cursor control device 514 may be combined into a single component or device (e.g., an LCD touch screen).

The processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute detection and aggregation instructions 525, for performing the operations and steps discussed herein. For example, the detection and aggregation instructions 525 may include instructions for obtaining indications of events associated with user accounts of a cloud provider. The detection and aggregation instructions 525 may include instructions for generating scores for the events based on the indications of the events and previous occurrences of the events associated with the user accounts of the cloud provider. The detection and aggregation instructions 525 may include instructions for aggregating a subset of the scores for a user account in the user accounts based on each score in the subset of scores meeting a threshold score and a subset of the events corresponding to the subset of the scores occurring with a time period. The detection and aggregation instructions 525 may include instructions for outputting an indication that the user account is compromised based on the aggregated subset of the scores.

The data storage device 518 may include a machine-readable storage medium 528 that stores the detection and aggregation instructions 525 (e.g., software) embodying any one or more of the methodologies of functions described herein. The detection and aggregation instructions 525 may also reside, completely or at least partially, within the main memory 504 or within the processing device 502 during execution thereof by the computer system 500; the main memory 504 and the processing device 502 also constituting machine-readable storage media. The detection and aggregation instructions 525 may further be transmitted or received over a network 520 via the network interface device 508.

While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “obtaining,” “generating,” “aggregating,” “outputting,” “inputting,” “transmitting,” “receiving,” “computing,” “calculating,” “scoring,” “accessing,” “displaying,” “storing,” “restricting,” “selecting,” “grouping,” “inputting,” “outputting,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission, or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
obtaining indications of events associated with user accounts of a cloud provider;
generating scores for the events based on the indications of the events and previous occurrences of the events associated with the user accounts of the cloud provider;
aggregating a subset of the scores for a user account in the user accounts based on each score in the subset of scores meeting a threshold score and a subset of the events corresponding to the subset of the scores occurring with a time period; and
outputting, by a processing device, an indication that the user account is compromised based on the aggregated subset of the scores.

2. The method of claim 1, wherein the obtaining the indications of the events associated with the user accounts of the cloud provider comprises obtaining an audit log of the cloud provider, wherein the audit log comprises identifiers for the events, identifiers for the user accounts, and timestamps of the events, and wherein the generating the scores for the events is based on the audit log.

3. The method of claim 1, wherein the indications of the events comprise first timestamps of the events, identifiers for the events, and identifiers for the user accounts, and wherein the generating the scores for the events comprises:
accessing data storage that stores second timestamps of the previous occurrences of the events occurring within the time period, identifiers for the previous occurrences of the events, and the identifiers for the user accounts; and
computing, for each event in the events for each user account in the user accounts, a score based on the first timestamps and the second timestamps.

4. The method of claim 1, further comprising:
generating a score for the user account based on the aggregated subset of the scores, and wherein the outputting the indication that the user account is compromised comprises outputting the indication that the user account is compromised based on the score exceeding a second threshold score.

5. The method of claim 1, wherein the outputting the indication that the user account is compromised comprises at least one of:
displaying the indication that the user account is compromised;
storing, in a data store, the indication that the user account is compromised; or
transmitting, over a network and to a computing device, the indication that the user account is compromised.

6. The method of claim 1, further comprising:
restricting the user account based on the indication that the user account is compromised.

7. The method of claim 1, wherein the events comprise application programming interface (API) calls originating from the user accounts to the cloud provider.

8. The method of claim 1, wherein each score in the scores is indicative of an unusualness of an event for the user account.

9. The method of claim 1, wherein each score in the scores for the events is independent from a type of an event.

10. The method of claim 1, wherein an event in the event comprises an application programming interface (API) call to determine storage locations provided by the cloud provider that are accessible to the user account.

11. The method of claim 1, wherein the outputting the indication that the user account is compromised comprises generating an incident report object based on the aggregated subset of the scores.

12. The method of claim 1, wherein each score in the scores is correlated with a frequency of use of an application programming interface (API) by the user account, wherein the API is provided by the cloud provider.

13. The method of claim 1, further comprising:
obtaining, subsequent to the generating the scores and prior to the aggregating the subset of the scores, an indication of an event associated with the user account; and
generating a score for the event based on a previous occurrence of the event associated with the user account, wherein the aggregating the subset of the scores comprises aggregating the subset of the scores additionally based on the score.

14. The method of claim 1, wherein the aggregating the subset of the scores for the user account comprises:
selecting the subset of the events based on each of the subset of events being associated with an identifier for the user account; and
grouping the subset of the scores together based on the selected subset of the events.

15. A system, comprising:
a processing device; and
a memory to store instructions that, when executed by the processing device, cause the processing device to:
obtain indications of events associated with user accounts of a cloud provider;
generate scores for the events based on the indications of the events and previous occurrences of the events associated with the user accounts of the cloud provider;
aggregate a subset of the scores for a user account in the user accounts based on each score in the subset of scores meeting a threshold score and a subset of the events corresponding to the subset of the scores occurring with a time period; and
output an indication that the user account is compromised based on the aggregated subset of the scores.

16. The system of claim 15, wherein the events comprise application programming interface (API) calls originating from the user accounts to the cloud provider.

17. The system of claim 15, wherein each score in the scores is indicative of an unusualness of an event for the user account.

18. The system of claim 15, wherein the processing device is further to:
generate a score for the user account based on the aggregated subset of the scores, and wherein to output the indication that the user account is compromised, the processing device is to output the indication that the user account is compromised based on the score exceeding a second threshold score.

19. The system of claim 15, wherein to obtain the indications of the events associated with the user accounts of the cloud provider, the processing device is to obtain an audit log of the cloud provider, wherein the audit log comprises identifiers for the events, identifiers for the user accounts, and timestamps of the events, and wherein to generate the scores for the events, the processing device is to generate the scores for the events based on the audit log.

20. A non-transitory computer readable medium, having instructions stored thereon which, when executed by a processing device, cause the processing device to:
obtain indications of events associated with user accounts of a cloud provider;
generate scores for the events based on the indications of the events and previous occurrences of the events associated with the user accounts of the cloud provider;
aggregate a subset of the scores for a user account in the user accounts based on each score in the subset of scores meeting a threshold score and a subset of the events corresponding to the subset of the scores occurring with a time period; and
output, by the processing device, an indication that the user account is compromised based on the aggregated subset of the scores.
